(19) United States
(12) Patent Application Publication
(10) Pub. No.: US 2026/0105715 A1
(43) Pub. Date: Apr. 16, 2026

(54) SINGLE IMAGE SENSOR MULTI-IMAGE LENSING CONCEPT FOR ANTISPOOFING FACEID, HYPERSPECTRAL IMAGING AND OTHER APPLICATIONS

(71) Applicant: Applied Materials, Inc., Santa Clara, CA (US)

(72) Inventors: Paul GALLAGHER, San Jose, CA (US); Wubin PANG, San Jose, CA (US); David Alexander SELL, Santa Clara, CA (US); Gauthier BRIERE, Hoofddorp (NL)

(21) Appl. No.: 19/115,858

(22) PCT Filed: Oct. 27, 2023
(86) PCT No.: PCT/US2023/036110

§ 371 Date: Mar. 27, 2025

Related U.S. Application Data
(60) Provisional application No. 63/420,243, filed on Oct. 28, 2022.

(51) Int. Cl. G06V 10/143; G06V 10/147; G06V 40/16; G06V 40/40; H04N 23/11; H04N 23/55

(52) U.S. Cl. CPC G06V 10/143; G06V 10/147; G06V 40/166; G06V 40/172; G06V 40/45; H04N 23/11; H04N 23/55

(57) ABSTRACT

Embodiments of the present disclosure generally relate to an optical system to prevent spoofing of the identity of users. In one embodiment, an optical system includes an image sensor operable to produce an output signal representative of a visible image and at least two infrared light (NIR) images, and a lens system. The lens system is operable to focus the visible image to a center portion of the image sensor and at least one NIR image to a first portion of the image sensor. The optical system further includes a polarizing system having a center area that allows the visible image to pass through and at least one polarizer on a first border of the polarizing system. The at least one polarizer on the first border allows a first NIR image to project along an optical path to the second portion of the image sensor.

### BACKGROUND

### Field

Embodiments of the present disclosure generally relate to an optical system to prevent spoofing of the identity of users.

### Description of the Related Art

Devices, such as smartphones and laptops, can be unlocked by a user positioning his or her face in front of the built in camera of the device. The camera takes an image of the user's face and compares the captured image to saved images of the authorized user stored in the memory. If the images match, the user is allowed access to the device. This method is vulnerable to spoofing attempts because a photograph positioned in front of the camera may be used to access the device. Other devices have more sophisticated methods that confirm the object is three-dimensional. These devices require more parts that increase the cost of the device. Accordingly, a new optical system and a method to prevent spoofing is needed.

### SUMMARY

In one embodiment, an optical system is provided. The optical system includes an image sensor operable to produce an output signal representative of a visible image and at least two infrared light (NIR) images, and a lens system disposed in front of the image sensor. The lens system is operable to focus or partially focus the visible image to a center portion of the image sensor and at least one NIR image to a first portion of the image sensor and at least another NIR image to a second portion of the image sensor. The optical system further includes a polarizing system. The polarizing system has a center area that allows the visible image to pass through, at least one polarizer on a first border of the polarizing system, and at least another polarizer on a second border of the polarizing system. The first border opposing the second border. The at least one polarizer on the first border allows a first NIR image to project along an optical path to the second portion of the image sensor. The at least another polarizer on the second border allows a second NIR image to project along the optical path to the second portion of the image sensor.

In another embodiment, a method of using an optical system is provided. The method includes producing an output signal representative of a visible image and four near infrared light (NIR) images. The output signal is obtained by capturing the visible image and the four NIR images from a polarizing system having four quarter-wave polarizers. The method further includes comparing the four NIR images to the visible image with a processor to determine whether the visible image includes human skin.

In another embodiment, a method of using an optical system is provided. The method includes forming images on an image sensor via light incident to a plurality of regions, the plurality of regions comprising at least a first region and a second region, and detecting whether a face is present in pixels of the first region using a processor. The method further includes confirming whether the face is present by detecting corresponding pixels of the second region if the face is detected in the first region by the processor, and initiating a predetermined action if the face is detected in both the first region and the second region.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 is a schematic view of an optical system, according to embodiments.

FIG. 2A is top view of a polarizing system to be used in an optical system, according to embodiments.

FIG. 2B is top view of a polarizing system to be used in an optical system, according to embodiments.

FIG. 2C is top view of a polarizing system to be used in an optical system, according to embodiments.

FIG. 3 is a flow diagram describing a method of using an optical system, according to embodiments.

FIG. 4 is a visual representation of a visible image and four near infrared images obtained by an optical system, according to embodiments.

FIG. 5 is a flow diagram describing a method of using an optical system, according to embodiments.

FIG. 6A a visual representation of a visible image and four near infrared images obtained by an optical system, according to embodiments.

FIG. 6B is a visual representation of a visible image and two near infrared images obtained by an optical system, according to embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to an optical system to prevent spoofing of the identity of users.

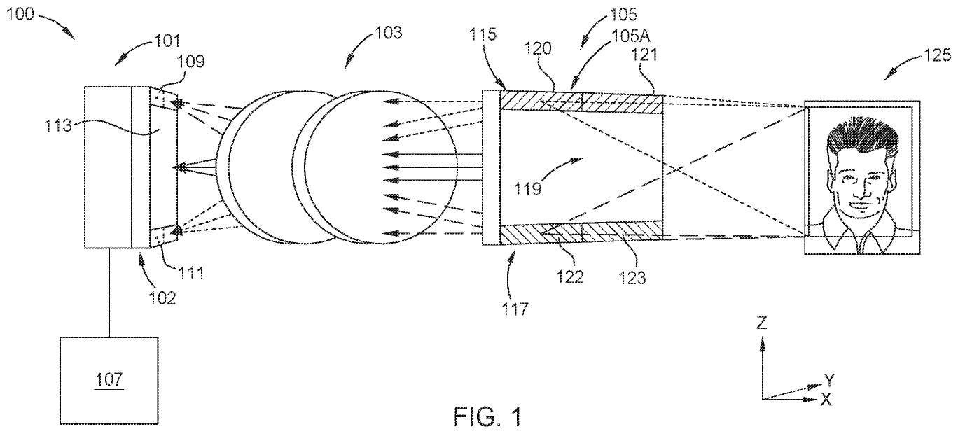

FIG. 1 is a schematic view of an optical system 100. The optical system includes an image sensor 101, a lens system 103, a polarizing system 105, and a processor 107. In some embodiments, the optical system 100 further includes a filter 102. The image sensor 101 is operable to produce an output signal. In one embodiment, which may be combined with other embodiment described herein, the output signal is representative of a visible image 401 and four near infrared light (NIR) images 402. In another embodiment, which may be combined with other embodiment described herein, the output signal is representative of the visible image 401 and two NIR images 402. In one embodiment, which may be combined with other embodiment described herein, the image sensor 101 includes a first portion, a second portion, a third portion, a fourth portion, and a center portion. The portions are positions on the image sensor that will capture the visible image 401 and the four NIR images 402. In another embodiment, which may be combined with other embodiment described herein, the image sensor 101 includes a first portion, a second portion, and a center portion. The portions are positions on the image sensor that will capture the visible image 401 and two NIR images 402.

In embodiments including the filter 102, the filter 102 is positioned directly in front of the image sensor 101. In some embodiments, the filter 102 is a cover glass of the image sensor 101. In other embodiments, the filter 102 is in contact with a cover glass of the image sensor 101. The filter 102 has a first NIR filter 109 and a second NIR filter 111 opposing each other on opposite borders of the filter 102. Between the first NIR filter 109 and the second NIR filter 111 is the center filter 113. The first NIR filter 109 and the second NIR filter 111 block visible light and allow NIR light to pass through into the image sensor 101 to form the NIR images 402. The center filter 113 allows visible light to pass into the image sensor 101 to capture the visible image 401. The center filter 113 blocks NIR light. The filter 102 may be rectangular or circular.

The lens system 103 is disposed in front of the filter 102. The lens system 103 is operable to focus or partially focus the visible image 401 through the center filter 113 to the center section of the image sensor 101. The lens system 103 is operable to focus or partially focus at least one NIR image 402 to the first NIR filter 109 and at least one NIR image 402 to the second NIR filter 111.

As shown in FIG. 1, the polarizing system 105 is a quartered polarizing system 105A. The quartered polarizing system 105A has a transparent center portion 119 that allows the visible image to pass through. The quartered polarizing system 105A includes a first border 115 and a second border 117. Two quarter-wave polarizers are adjacent to each other on the first border 115 of the quartered polarizing system 105A. Two quarter-wave polarizers are adjacent to each other on the second border 117 of the quartered polarizing system 105A. The first border 115 opposes the second border 117.

The two quarter-wave polarizers on the first border 115 allows the two NIR images to project along optical paths to the second NIR filter 111. The two quarter-wave polarizers on the second border 117 allows the two NIR images to project along an optical path to the first NIR filter 109. The two quarter-wave polarizers on the first border 115 include a first quarter-wave polarizer 120 and a second quarter-wave polarizer 121. The first quarter-wave polarizer 120 has a first field of view (FOV) to project a first NIR image 403 on a first optical path. The second quarter-wave polarizer 121 has a second FOV to project a second NIR image 404 on a second optical path. The second quarter-wave polarizer 121 is disposed on the first border 115 of the quartered polarizing system 105A adjacent to the first quarter-wave polarizer 120.

The two quarter-wave polarizers on the second border 117 include a third quarter-wave polarizer 122 and a fourth quarter-wave polarizer 123. The third quarter-wave polarizer 122 has a third FOV to project a third NIR image 405 on a third optical path. The fourth quarter-wave polarizer 123 has a fourth FOV to project a fourth NIR image 406 on a fourth optical path. The fourth quarter-wave polarizer 123 is disposed on the second border 117 of the polarizing system 105 adjacent to the third quarter-wave polarizer 122. The transparent center portion 119 has a center FOV to project the visible image 401 on a central optical path. The center FOV, the first FOV, the second FOV, the third FOV, and the fourth FOV overlap a common point on an object disposed in front of the quartered polarizing system 105A. The polarizations of the four quarter-wave polarizers are different to give the four NIR images different polarizations. The different polarizations also allow the four quarter-wave polarizers to direct light on the four optical paths.

The image sensor 101 has a first portion, a second portion, a third portion, fourth portion, and center portion. In some embodiments, the first portion is positioned on a top section of the image sensor 101. In other embodiments, the first portion is positioned on a first side section of the image sensor 101. The first portion is on the fourth optical path and captures the fourth NIR image 406. The second portion is adjacent to the first portion. The second portion is on the third optical path and captures the third NIR image 405. In some embodiments, the third portion is positioned on a bottom section of the image sensor. In other embodiments, the third portion is positioned on a second side section of the image sensor 101 opposite the first side section. The third portion is on the second optical path and captures the second NIR image. The fourth portion is adjacent to the third portion. The fourth portion is on the first optical path and captures the first NIR image. The center portion is on the central optical path and captures the visible image.

The optical paths are the paths the light travel from an object 125 to the image sensor 101. As shown in FIG. 1, the object 125 is a human face. The first optical path is created by quarter-wave polarization of the first quarter-wave polarizer 120 and the lens system 103. The second optical path is created by quarter-wave polarization of the second quarter-wave polarizer 121 and the lens system 103. The third optical path is created by quarter-wave polarization of the third quarter-wave polarizer 122 and the lens system 103. The fourth optical path is created by quarter-wave polarization of the fourth quarter-wave polarizer 123 and the lens system 103.

The processor 107 is connected to the image sensor 101 is operable to receive the output signal produced by the image sensor 101. The processor 107 includes a central processing unit (CPU), a memory containing instructions and benchmark images, and support circuits for the CPU. The processor 107 is communicatively coupled to the image sensor 101. The memory, or non-transitory computer readable medium, is one or more of a readily available memory such as random access memory (RAM), dynamic random access memory (DRAM), static RAM (SRAM), and synchronous dynamic RAM (SDRAM (e.g., DDR1, DDR2, DDR3, DDR3L, LPDDR3, DDR4, LPDDR4, and the like)), read only memory (ROM), floppy disk, hard disk, flash drive, or any other form of digital storage, local or remote. The support circuits of the processor 107 are coupled to the CPU for supporting the CPU. The support circuits may include cache, power supplies, clock circuits, input/output circuitry and subsystems, and the like. The processor 107 is configured to conduct any of the operations described herein. For example, the instructions stored on the memory, when executed, can cause one or more of operations of FIG. 1 or method 300.

The various operations described herein (such as the operations of FIG. 1, and/or method 300) can be conducted automatically using the processor 107, or can be conducted automatically or manually with certain operations conducted by a user.

When the object 125 is the human face, the human face is displayed in the center FOV and the visible image 401. The NIR images 402 are also of the human face formed with NIR light. The NIR light has a wavelength between 700 nm and 1100 nm. In some embodiments the NIR light used is between 840 nm and 1040 nm, such as 940 nm. The visible image 401 includes the entire human face. The NIR images 402 includes at least of portions of the human face.

In some embodiments, the optical system 100 is designed such that the image sensor 101 and the lens system 103 are part of the camera system of a device. The polarizing system 105 is disposed in front of the camera system on the device. The device uses the optical system 100 to verify the identification of a user to operate the device. The device requires identification to operate. The processor 107 may be a processor present in the device.

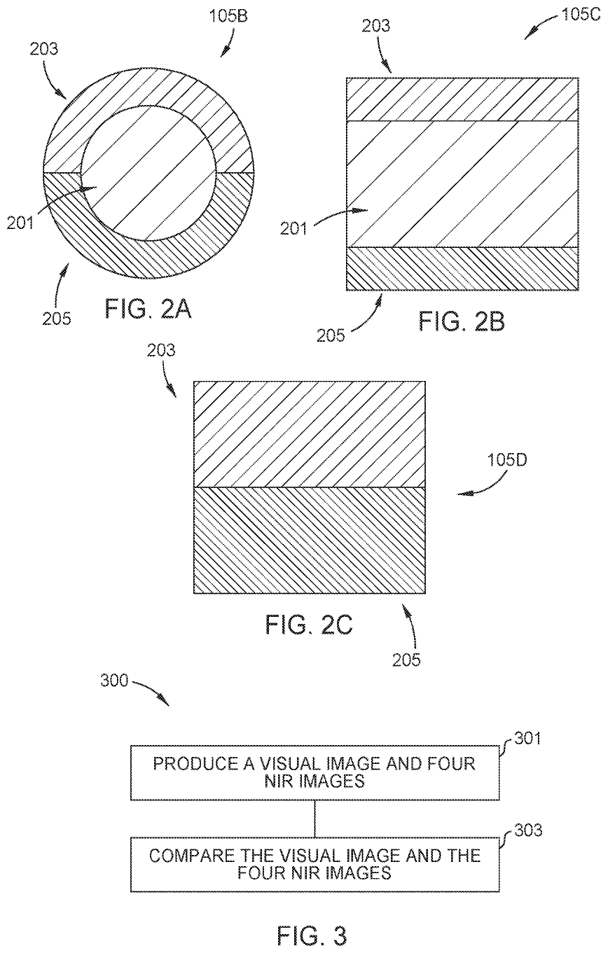

FIGS. 2A-2C show three alternative embodiments for the polarizing system 105. The three polarizing systems 105B-D use S-polarization and P-polarization to polarize the NIR light. In some embodiments, an optical systems 100 using a polarizing systems 105B-D may not have the filter 102. The visible light and NIR light travel in a similar way as described above. FIG. 2A is top view of a circular polarizing system 105B. The circular polarizing system 105B includes a center visible light filter 201, an S-polarized NIR filter 203, and a P-polarized NIR filter 205. The circular polarizing system 105B is circular in shape. The center visible light filter 201 is circular in shape and surrounded by the S-polarized NIR filter 203 on a first border and the S-polarized NIR filter 203 on a second border. The S-polarized NIR filter 203 covers a first hemisphere of the center visible light filter 201 and the P-polarized NIR filter 205 covers an opposing second hemisphere of the center visible light filter 201. In these embodiments, the image sensor 101 only has a center portion, a first portion, and a second portion which shapes correspond to the circular polarizing system 105B.

FIG. 2B is top view of a rectangular polarizing system 105C. The rectangular polarizing system 105C has an S-polarized NIR filter 203 and a P-polarized NIR filter 205 opposing each other on opposite borders of the rectangular polarizing system 105C. Between the S-polarized NIR filter 203 and the P-polarized NIR filter 205 is the center visible light filter 201. The rectangular polarizing system 105C is rectangular in shape. In these embodiments, the image sensor 101 only has a center portion, a first portion, and a second portion which shapes correspond to the rectangular polarizing system 105C. FIG. 2C is top view of an optical polarizing system 105D. The optical polarizing system 105D include an S-polarized NIR filter 203 and a P-polarized NIR filter 205. In the embodiments of the polarizing system 105D, the S-polarized NIR filter 203 and the P-polarized NIR filter 205 are meta-optics. The polarizing systems 105B-D allows a first NIR image 601 to project along an optical path to the second portion of the image sensor 101, a second NIR image 602 to project along the optical path to the second portion of the image sensor 101, and the visible image 401 to project the center portion of the image sensor 101.

FIG. 3 is a flow diagram describing a method 300 of using an optical system 100. At operation 301, an output signal is produced. The output signal is representative of the visible image 401 and the four NIR images 402. The output signal is obtained by capturing the visible image 401 and the four NIR images 402 from the polarizing system 105 on the image sensor 101. The output signal is transmitted from the image sensor 101 to the processor 107.

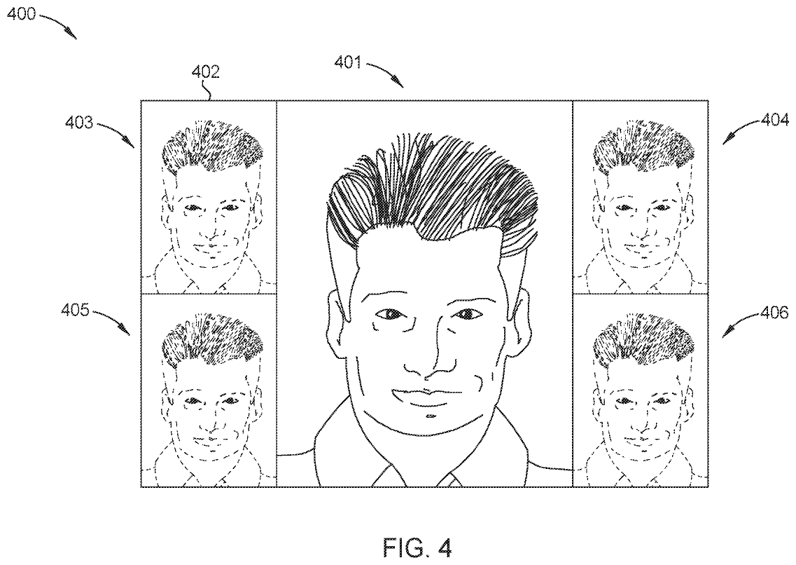

FIG. 4 is a visual representation 400 of the visible image 401 and the four NIR images 402 obtained by the optical system 100. The visual representation 400 is the data sent to the processor 107 by the image sensor 101 via the output signal. The visible image 401 is captured based on the visible FOV created by light in the visible spectrum. The visible image 401 capture the image in visible light. The four NIR images 402 includes the first NIR image 403, the second NIR image 404, the third NIR image 405, and the fourth NIR image 406. The NIR images 402 capture the image in NIR light. The four NIR images 402 are at different polarizations and compression levels.

At operation 303, the visible image 401 and the four NIR images 402 are compared. The comparison completed by the processor 107 concurrent with obtaining the output signal. The visible image 401 is an image of a human face of the user of the device. The four NIR images 402 are at least portions of the human face. Human skin has a NIR polarized differential response in the NIR images 402. This response may be used identify human skin is depicted in the NIR images 402 based on energy levels of the NIR images 402. Human skin has a unique response from differently polarized NIR light. Specifically, the reflected energies off human skin. The processor 107, confirms the presence of human skin on the visible image 401 to ensure the user cannot spoof access to the device with a picture of an authorized user. The device is accessed upon confirmation through an allowance action. A denial action blocks the user from gaining access to the device.

In some embodiments, during comparison of the NIR images 402, points on the visible image 401 are selected. The location of these points are projected onto the four NIR images 402. Those locations are used on the NIR images 402 to confirm human skin is present. For example, if a forehead of the human face is visible, points of the forehead cam be mapped to the four NIR images 402 and human skin can be confirmed even if the user is wearing a facemask.

The optical system 100 is positioned a set distance from the human face to have the five FOVs be relatively the same. If the optical system 100 is positioned outside the set distance from the human face, the FOVs of the visible image 401 four NIR images 402 may be different. The central FOV and therefore the visible image 401 are unaffected by the distance. The user or device initiates a picture to be taken of the human face of the user. If a traditional flash of visible light is needed to be shined, a flash of NIR light is shined as well. If no traditional flash is needed, sunlight will provide all the visible and NIR light. Light is reflected off the human face. Visible light in the visible spectrum is reflected off the human face and travels through the transparent center portion 119 of the polarizing system 105. The visible light travels on the central optical path through the lens system 103. The visible light passes through the center filter 113 to the center portion of the image sensor 101. The visible light on the central optical path is projecting the central FOV which includes the whole human face. The visible image 401 is captured by the image sensor 101.

At the same time, the visible light is reflected off the human face, NIR light in the NIR spectrum is reflected off the human face. The NIR light passes through the polarizing system 105 on the first quarter-wave polarizer 120, the second quarter-wave polarizer 121, the third quarter-wave polarizer 122, and the fourth quarter-wave polarizer 123. The NIR light passing through the first quarter-wave polarizer 120 is polarized and is projected on the first optical path. The NIR light on the first optical path includes the first FOV which includes at least a portion of the human face. The NIR light on the first optical path travels through the lens system 103. The NIR light is focused on the second NIR filter 111 and passes through to the fourth portion of the image sensor 101. The image sensor 101 forms the first NIR image 403.

The NIR light passing through the second quarter-wave polarizer 121 is polarized and is projected on the second optical path. The NIR light on the second optical path includes the second FOV which includes at least a portion of the human face. The NIR light on the second optical path travels through the lens system 103. The NIR light is focused on second NIR filter 111 and passes through to the third portion of the image sensor 101. The image sensor 101 forms the second NIR image 404.

The NIR light passing through the third quarter-wave polarizer 122 is polarized and is projected on the third optical path. The NIR light on the third optical path includes the third FOV which includes at least a portion of the human face. The NIR light on the third optical path travels through the lens system 103. The NIR light is focused on the first NIR filter 109 and passes through to the second portion of the image sensor 101. The image sensor 101 forms the third NIR image 405.

The NIR light passing through the fourth quarter-wave polarizer 123 is polarized and is projected on the fourth optical path. The NIR light on the fourth optical path includes the fourth FOV which includes at least a portion of the human face. The NIR light on the fourth optical path travels through the lens system 103. The NIR light is focused on the first NIR filter 109 and passes through to the first portion of the image sensor 101. The image sensor 101 forms the fourth NIR image 406.

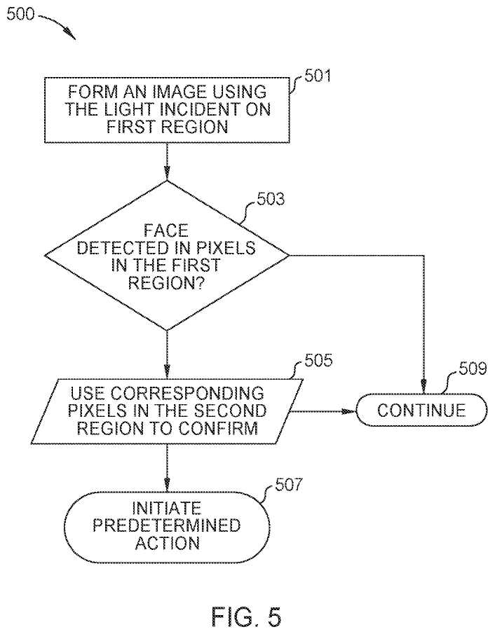

FIG. 5 is a flow diagram describing a method 500 of using an optical system 100. At operation 501 images are formed. The images are formed using light incident a plurality of regions including at least a first region and a second region. In some embodiments, the first region corresponds to the center portion of the image sensor 101 and the second region corresponds to a second portion of the image sensor 101. The images can be the visual representation 400, a visual representation 600A, or a visual representation 600B. The images are captured by the image sensor 101. The images include the visible image 401 formed from the visible FOV from a first region and at least one NIR image 402 formed from the second region. In some embodiments, the images include the visible image 401 and the four NIR images 402 as shown in FIG. 4. The images are obtained by capturing the visible image 401 and the four NIR images 402 from the polarizing system 105 on the image sensor 101 as described above. The images are transmitted from the image sensor 101 to the processor 107.

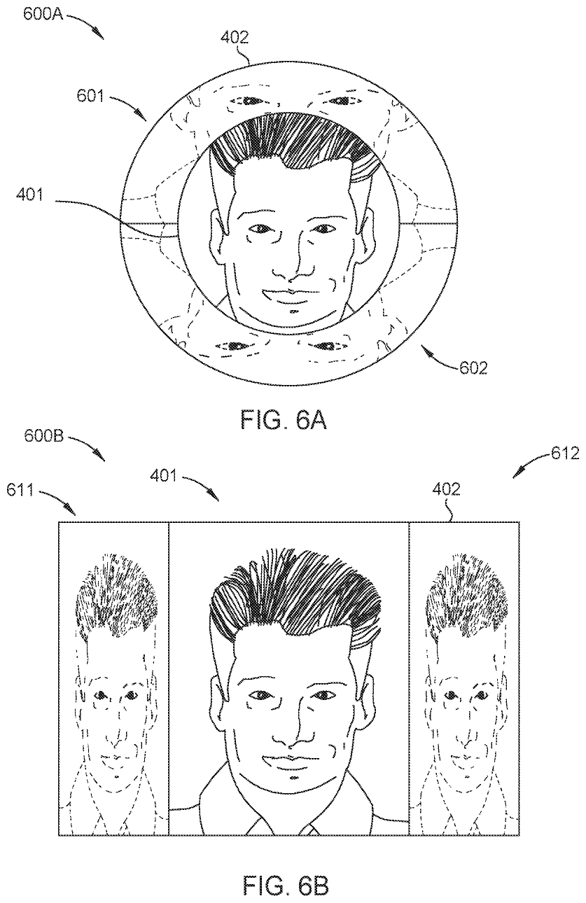

FIG. 6A is the visual representation 600A of the visible image 401 and the two NIR images 402 obtained by the optical system 100 using the polarizing system 105B or the polarizing system 105C. In some embodiments, the visual representation 600A is the images sent to the processor 107 by the image sensor 101. The visible image 401 is captured based on the visible FOV created by light in the visible spectrum. The visible image 401 captures the image in visible light. The two NIR images 402 includes the first NIR image 601, and the second NIR image 602. The first NIR image 601 and the second NIR image 602 are different from the NIR images 402 of FIG. 4 due to the different polarizers and geometry of the polarizing system 105B or the polarizing system 105C. The first NIR image 601 and the second NIR image 602 are at different polarizations.

FIG. 6B is the visual representation 600B of the visible image 401 and the two NIR images 402 obtained by the optical system 100 using the polarizing system 105D. In some embodiments, the visual representation 600B is the images sent to the processor 107 by the image sensor 101. The visible image 401 is captured based on the visible FOV created by light in the visible spectrum. The visible image 401 captures the image in visible light. The two NIR images 402 includes the first NIR image 611, and the second NIR image 602. The first NIR image 601 and the second NIR image 612 are different from the NIR images 402 of FIG. 4 due to the different polarizers and geometry of the polarizing system 105D. The first NIR image 611 and the second NIR image 612 are at different polarizations.

At operation 503, the processor 107 detects whether the human face is present in the first region. The processor 107 scans the pixels of the first region searching for a face. The first region includes the visible image 401. In some embodiments, the processor 107 compares the visible image 401 from the first region to a stored image of a face of an authorized user. If the human face is not detected in the first region, at operation 509 access is denied to the device.

At operation 505, the processor 107 confirms whether the human face is present in the second region. The processor detects whether the human face is present in the corresponding pixels of the second region. The corresponding pixels of the second region correspond to the location of the pixels in the first region. The second region includes an NIR image 402. In some embodiments, the human face is confirmed by using the NIR polarized differential response of the NIR images 402 to confirm the presence of human skin based on energy levels of the NIR images 402. If the human face is not detected in the second region, at operation 509 access is denied to the device.

At operation 507, a predetermined action is initiated. if the human face is detected in both the first region and the second region. The predetermined action comprises allowing access to the device connected to the optical system 100.

At operation 509, access is denied to the device. The processor 107 denies access to the device if the human face is not detected in the first region or the human face is not confirmed in the second region. In some embodiments, after denial the method 500 can be repeated to gain access to the device.

The method 500 contemplates may use two or more regions to detect and confirm a human face. In some embodiments three regions may be used via one of the polarizing systems 105B-D. The third region corresponding to a second portion of the image sensor 101. In some other embodiments, five regions may be used via the quartered polarizing system 105A. The third region corresponding to a second portion of the image sensor 101 and the second NIR image 404. The fourth region corresponding to a third portion of the image sensor 101 and the third NIR image 405. The fifth region corresponding to a fourth portion of the image sensor 101 and the fourth NIR image 406.

In summation, embodiments of the present disclosure generally relate to an optical system to prevent spoofing of the identity of users. The optical system includes an image sensor, lens system, processer, and polarizing system. The optical system and method provide a way to prevent spoofing authorization to access devices such as smart phones. The optical system does not require a special projector, a dedicated second sensor like current methods. The optical system can work with partially covered faces and during the day and at night.

While the foregoing is directed to examples of the present disclosure, other and further examples of the disclosure may be devised without departing from the basic scope thereof, and the scope thereof is determined by the claims that follow.

What is claimed is:

1. An optical system, comprising:
an image sensor operable to produce an output signal representative of a visible image and at least two infrared light (NIR) images;
a lens system disposed in front of the image sensor, the lens system operable to focus or partially focus the visible image to a center portion of the image sensor and at least one NIR image to a first portion of the image sensor and at least another NIR image to a second portion of the image sensor; and
a polarizing system, having a center area that allows the visible image to pass through and at least one polarizer on a first border of the polarizing system and at least another polarizer on a second border of the polarizing system, the first border opposing the second border, the at least one polarizer on the first border allows a first NIR image to project along an optical path to the second portion of the image sensor and the at least another polarizer on the second border allows a second NIR image to project along the optical path to the second portion of the image sensor.

2. The optical system of claim 1, wherein four NIR images are produced by the image sensor.

3. The optical system of claim 2, wherein the optical system further comprises a filter positioned in front of the image sensor, the filter has a first NIR filter and a second NIR filter opposing each other on opposite borders of the filter and a center filter.

4. The optical system of claim 3, wherein the polarizing system comprises:
a first quarter-wave polarizer disposed on the first border of the quartered polarizing system, the first quarter-wave polarizer having a first field of view (FOV) to project a first NIR image on a first optical path;
a second quarter-wave polarizer disposed on the first border of the quartered polarizing system adjacent to the first quarter-wave polarizer, the second quarter-wave polarizer having a second FOV to project a second NIR image on a second optical path;
a third quarter-wave polarizer disposed on the second border, the third quarter-wave polarizer having a third FOV to project a third NIR image on a third optical path;
a fourth quarter-wave polarizer disposed on the second border of the quartered polarizing system adjacent to the third quarter-wave polarizer, the fourth quarter-wave polarizer having a fourth FOV to project a fourth NIR image on a fourth optical path; and
the center area being transparent having a center FOV to project the visible image on a central optical path, wherein the center FOV and the first FOV through the fourth FOV are operable to overlap a point on an object when the object is disposed in front of the polarizing system.

5. The optical system of claim 4, wherein:
a first portion of the image sensor is on the fourth optical path to capture the fourth NIR image;
a second portion of the image sensor is adjacent to the first portion, the second portion is on the third optical path to capture the third NIR image;
a third portion of the image sensor is on the second optical path to capture the second NIR image;
a fourth portion of the image sensor is adjacent to the third portion, the fourth portion on the first optical path to capture the first NIR image; and
a center portion on the central optical path to capture the visible image.

6. The optical system of claim 5, wherein:
the first optical path is to be created by quarter-wave polarization of the first quarter-wave polarizer and the lens system;
the second optical path is to be created by quarter-wave polarization of the second quarter-wave polarizer and the lens system;
the third optical path is to be created by quarter-wave polarization of the third quarter-wave polarizer and the lens system; and
the fourth optical path is to be created by quarter-wave polarization of the fourth quarter-wave polarizer and the lens system.

7. The optical system of claim 5, further comprising a processor connected to the image sensor operable to receive the output signal.

8. The optical system of claim 7, wherein the object to be displayed in the center FOV and visible image is a human face.

9. The optical system of claim 8, wherein the processor is configured to compare the four NIR images to the visible image to determine whether the visible image includes human skin.

10. The optical system of claim 1, wherein the polarizing system comprises:
an S-polarized NIR filter disposed on the first border of the polarizing system, the S-polarized NIR filter having a first field of view (FOV) to project a first NIR image on a first optical path;
a P-polarized NIR filter disposed on the first border of the polarizing system, the P-polarized NIR filter having a second field of view (FOV) to project a first NIR image on a first optical path; and
the center area being a center visible light filter having a center FOV to project the visible image on a central optical path, wherein the center FOV, the first FOV, and the second FOV are operable to overlap a point on an object when the object is disposed in front of the polarizing system.

11. The optical system of claim 1, wherein the polarizing system comprises an S-polarized NIR filter and a P-polarized NIR filter, the S-polarized NIR filter and the P-polarized NIR filter are meta-optics.

12. The optical system of claim 1, wherein the NIR images are formed with NIR light with a wavelength between 700 nm and 1100 nm.

13. The optical system of claim 1, wherein the image sensor and the lens system are a part of a camera system.

14. The optical system of claim 1, further comprising a device requiring identification of a user to operate.

15. A method of using an optical system, comprising:
producing an output signal representative of a visible image and four near infrared light (NIR) images, wherein the output signal is obtained by capturing the visible image and the four NIR images from a polarizing system having four quarter-wave polarizers; and
comparing the four NIR images to the visible image with a processor to determine whether the visible image includes human skin.

16. The method of claim 15, wherein a NIR polarized differential response of the NIR images can confirm human skin in the NIR images based on energy levels of the NIR images.

17. The method of claim 16, wherein the visible image corresponds to a human face and four NIR images correspond to at least a portion of the human face.

18. The method of claim 17, wherein the optical system used comprises:
an image sensor operable to produce the output signal,
a filter in front of the image sensor, the filter having a first NIR filter and a second NIR filter opposing each other on opposite borders of the filter and a center filter;
a lens system disposed in front of the filter, the lens system operable to focus or partially focus the visible image to the center filter of the filter and two NIR images to the first NIR filter and two NIR images to the second NIR filter; and
a polarizing system, having a transparent center portion that allows the visible image to pass through and two quarter-wave polarizers adjacent to each other on a first border of the polarizing system and two quarter-wave polarizers on a second border of the polarizing system, the first border opposing second border, the two quarter-wave polarizers on the first border allows the two NIR images to project along optical paths to the second NIR filter and the two quarter-wave polarizers on the second border allows the two NIR images to project along optical paths to the first NIR filter.

19. The method of claim 18, wherein the polarizing system comprises:
a first quarter-wave polarizer disposed on the first border of the polarizing system, the first quarter-wave polarizer having a first field of view (FOV) to project a first NIR image on a first optical path;
a second quarter-wave polarizer disposed on the first border of the polarizing system adjacent to the first quarter-wave polarizer, the second quarter-wave polarizer having a second FOV to project a second NIR image on a second optical path;
a third quarter-wave polarizer disposed on the second border, the third quarter-wave polarizer having a third FOV to project a third NIR image on a third optical path;
a fourth quarter-wave polarizer disposed on the second border of the polarizing system adjacent to the third quarter-wave polarizer, the fourth quarter-wave polarizer having a fourth FOV to project a fourth NIR image on a fourth optical path; and
the transparent center portion having a center FOV to project the visible image on a central optical path, wherein the center FOV and the first FOV through the fourth FOV overlap a point on an object disposed in front of the polarizing system.

20. The method of claim 15, wherein the optical system is part of a device requiring identification of a user to access.

21. The method of claim 20, wherein if the processor confirms human skin is present, the processor issues an allowance action to the user of the device.

22. The method of claim 21, wherein if the processor cannot identify human skin, the processor issues a denial action to the user of the device.

23. A method of using an optical system, comprising:
forming images on an image sensor via light incident to a plurality of regions, the plurality of regions comprising at least a first region and a second region;
detecting whether a face is present in pixels of the first region using a processor;
confirming whether the face is present by detecting corresponding pixels of the second region if the face is detected in the first region by the processor; and
initiating a predetermined action if the face is detected in both the first region and the second region.

24. The method of claim 23, wherein the images include a visible image in the first region and at least a first near infrared (NIR) image in a second region, the NIR image formed from NIR light.

25. The method of claim 23, wherein detecting the face in the first region is completed by comparing to a stored image of an authorized users face.

26. The method of claim 24, wherein confirming whether the face is present includes using an NIR polarized differential response of the NIR image to confirm human skin is present based on energy levels of the NIR image.

27. The method of claim 23, wherein the predetermined action comprises allowing access to a device connected to an optical system.

28. The method of claim 27, further comprising denying access to the device if the face is not detected in the first region or the face is not confirmed in the second region.
